(19) United States
(12) Patent Application Publication
(10) Pub. No.: US 2015/0262184 A1
(43) Pub. Date: Sep. 17, 2015

(54) TWO STAGE RISK MODEL BUILDING AND EVALUATION

(71) Applicant: MICROSOFT CORPORATION, REDMOND, WA (US)

(72) Inventors: Shoou-Jiun Wang, Redmond, WA (US); Justin Hobart, Kirkland, WA (US); Angang Zhang, Blacksburg, VA (US)

(73) Assignee: MICROSOFT CORPORATION, REDMOND, WA (US)

(21) Appl. No.: 14/205,715

(22) Filed: Mar. 12, 2014

(51) Int. Cl. G06Q 20/40; G06Q 10/06

(52) U.S. Cl. CPC G06Q 20/4016; G06Q 10/067

(57) ABSTRACT

A two stage model in which the first stage of the model applies a different weighting schema to different types of transactions in a transaction-based system is described. The first stage of the model focuses on capturing currently known patterns that indicate bad transactions. The second stage of the model focuses on rejecting transactions that are approved by the current model, with the objective of maximizing a measurable goal. Business knowledge is used to lower the cost of finding the optimal solution of the model by estimating parameters provided to the first and second stages of the model. Evaluation of the model accounts for retry transactions and for churn. Parameters associated with the model that maximizes the goal can be selected for a future model.

### BACKGROUND

Risk modeling refers to the use of formal techniques to calculate risk. For example, financial risk modeling uses econometric techniques to determine the aggregate risk in a financial portfolio. Financial portfolio risk modeling can be used to make forecasts of potential losses that can occur in the portfolio.

Similarly, risk models can be used to determine when to accept or reject a transaction in a computerized transaction-based system. Within a group of transactions, some of the transactions may be fraudulent. A fraudulent transaction can be, for example, a transaction in which a stolen credit card is used or a transaction in which someone wrongfully uses someone else's account. Thus, many transaction-based computer systems employ risk models that attempt to recognize usage patterns associated with fraud. For example, if a user has historically generated transactions from locations in the vicinity of the zip code associated with his billing address, a transaction coming from a location on the other side of the planet may have a certain degree of likelihood of being fraudulent. A risk model typically attempts to learn from past mistakes and past successes. Using machine learning algorithms, an existing risk model can be modified to create a new model.

### SUMMARY

A risk analysis model can be built in two stages. The model may not have an underlying assumption concerning the distribution of the transaction population. For example, the model does not assume that the rejected population has a similar distributional shape to the approved population. In the first stage of the model building, a transaction status can be relabeled based on known facts. A rejected transaction made by a good user, a user whose approved transactions are actually good, can be relabeled “good”. A rejected transaction made by a bad user, a user whose approved transactions are actually bad, can be relabeled “bad”. Transactions for a user who has submitted both actually good and actually bad transactions within a specified time period can be excluded from consideration.

A weighting schema can be applied to different types of transactions in a computerized transaction-based system. A first weight (x) can be given to actually good transactions that are approved by the model, however the term “good” is defined. A second weight (y) can be given to rejected transactions whose status (actually good or actually bad) is not known. A third weight (z) can be given to transactions approved by the model that are actually bad, however the term “bad” is defined. The first stage of model building can focus on capturing currently known patterns of aspects of transactions that indicate that a transaction is actually bad. The second stage of model building can focus on rejecting transactions that are currently approved but are actually bad with the objective of maximizing a measurable goal. In a second stage of model building, certain of the transactions received by the first stage of the model can be excluded and a second model can be built on the remaining transactions, to which equal weighting is applied.

Two stage risk model building for a computerized transaction-based system comprising an order processing system is described. The model may not have an underlying assumption concerning the distribution of the transaction population. In the first stage of the model building, transactions can be relabeled based on known facts. Rejected transactions made by good users, users whose approved transactions are actually good, can be relabeled “good”. Rejected transactions made by bad users, users whose approved transactions are actually bad, can be relabeled “bad”. Transactions for a user who has submitted both good and bad transactions can be excluded from consideration.

In the first stage of model building, application of a weighting schema that weights different types of transactions differently is described. A first weight (x) can be given to transactions approved by the model that are actually good, where an actually good transaction is defined to be a non-fraudulent transaction. A second weight (y) can be given to rejected transactions whose status (actually good or actually bad) is not known. The actions requested by a rejected transaction are not performed by the computerized transaction-based system. A third weight (z) can be given to transactions approved by the model that are actually bad, where an actually bad transaction is defined to be a fraudulent transaction. The first stage of model building can focus on capturing currently known patterns that indicate fraud. The second stage of model building can focus on rejecting transactions that are currently approved but are actually bad with an objective of maximizing revenue (net profit value). In a second stage of model building, certain of the transactions can be excluded from consideration. A second model can be built on the remaining transactions, to which an equal weighting schema is applied.

A current model and/or a new model can be evaluated for a measureable metric such as but not limited to net profit value (NPV). Evaluating the current model is straightforward because the true status of all approved transactions is known. Evaluating the new model which is built upon the outcome of the current model is challenging because the true status of the transactions approved by the new model but rejected by the current model is unknown. Also, when the new model rejects a transaction from a good user, it is unknown if the user will retry his transaction or churn because to the experience of having his transaction rejected. The model evaluation presented herein develops a way to adjust to account for retry transactions and for churn. Churn refers to the loss of users because the user's transaction(s) are rejected. Failing to adjust for retry transactions can cause model net profit to be over-estimated. Failing to adjust for churn can cause net profits to be under-estimated when the model reduces the number of false positives generated.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings:

FIG. 1a illustrates an example of a system 100 that builds a two stage risk model in accordance with aspects of the subject matter described herein;

FIG. 1b illustrates an example of a system 101 that illustrates evaluation of a current model and a new model in accordance with aspects of the subject matter described herein;

FIG. 2a illustrates an example of a method 200 that builds a model in two stages and evaluates models in accordance with aspects of the subject matter disclosed herein;

FIG. 2b illustrates an example of a method 201 that provides more detail on a portion of method 200 in accordance with aspects of the subject matter disclosed herein;

FIG. 2c illustrates an example of a method 203 that can evaluate risk models in accordance with aspects of the subject matter described herein; and

FIG. 3 is a block diagram of an example of a computing environment in accordance with aspects of the subject matter disclosed herein.

### DETAILED DESCRIPTION

### Overview

When a computerized transaction-based system receives a transaction, a risk model may be used to attempt to determine if the transaction is a good (e.g., non-fraudulent) transaction or a bad (e.g., fraudulent) transaction. A risk model typically examines a characteristic of a transaction, compares it with equivalent characteristics of actually good transactions and actually bad transactions and using complex algorithms assigns a risk score to the transaction for that characteristic. The risk scores associated with different aspects of a transaction can be aggregated to determine a degree of risk that the model assigns to the transaction as a whole. The risk score can be used to help determine whether a particular transaction will be labeled “good” or will be labeled “bad”. The risk score can be used to determine if the transaction will be approved (in which case the actions requested by the transaction typically will be performed) or rejected (in which case the actions requested by the transaction typically will not be performed). In accordance with aspects of the subject matter described herein, non-fraudulent transactions are actually good transactions and fraudulent transactions are actually bad transactions. Ideally, the actions requested by all actually good transactions are performed and the actions requested by all actually bad transactions are refused (not performed). Because no risk model is perfect, in actuality some actually good transactions will in all likelihood be rejected (because, for example, an actually good transactions is labeled “bad” by the model) and the actions requested by some actually bad transactions in all likelihood will be performed (because, for example, an actually bad transaction is labeled “good” by the model and is not rejected). In each of these cases, there is the possibility that revenue will be lost.

A transaction that is approved is either actually a good transaction, in which case the model has correctly labeled the transaction, or is actually a bad transaction that has been mislabeled “good”. Actually bad transactions that are mislabeled “good” and are executed (the actions requested by the transaction are performed) typically lose revenue. A transaction that is rejected is either actually a bad transaction, in which case the model has correctly labeled the transaction, or the transaction is actually a good transaction that has been mislabeled “bad”. Good transactions that are mislabeled “bad” and are not executed typically fail to make revenue that could be made.

Transactions that are rejected (whether actually good or actually bad) cannot be used to improve the model because no feedback is returned. If rejected transactions are not processed (that is, the actions requested by the transaction are not performed), it is impossible to know for sure how many of the rejected transactions are actually good (e.g., non-fraudulent) and how many are actually bad (e.g., fraudulent). Rejecting transactions can decrease revenue. Because the actions requested by rejected transactions are not performed, the number of false positives (rejected transactions that are actually not fraudulent transactions) generated in the current model cannot be reduced when the outcome of the current model is used to build a new model. Moreover, a non-fraudulent user who is rejected may not return to the site that rejected him (referred to as “churn”). Instead he may place his order elsewhere.

How accurately a model predicts reality typically depends on how well the model assigns labels to transactions. For example, a (relatively) large percentage of fraud indicators deriving from the reject population (for which the true status is unknown) and a small percentage deriving from known bad transactions (e.g., known to be bad because, for example, a purchase transaction was backed out by filing a charge-back) calls into question the degree of trust that can be placed on how well the transactions have been labeled. To address possible mislabeling of transactions by the model, in accordance with aspects of the subject matter described herein, rejected transactions can be relabeled based on the known facts during a first stage of model building. Rejected transactions made by good users (that is, a good user is a user whose approved transactions are non-fraudulent) can be relabeled “good”. Rejected transactions made by bad users (a bad user is a user whose approved transactions are fraudulent) can be relabeled “bad”. Those users whose transactions within a short period of time include both actually good transactions and actually bad transactions can be excluded from analysis.

In a first stage of model building, a weighting schema can be applied to the different types of transactions. A first weight (e.g., x) can be associated with approved, actually good transactions: transactions that were approved by a current model and that are known to be non-fraudulent transactions. A second weight (e.g., y) can be associated with rejected transactions, transactions that were declined by the current model but whose actual status (fraudulent or non-fraudulent) is unknown and a third weight (e.g., z) can be associated with transactions that were approved by the current model but which are actually fraudulent. In a first stage of the two stage model, a logistic regression or other machine learning technique can be performed on the transactions (including transactions that were relabeled) using the xyz weighting schema. In accordance with some aspects of the subject matter described herein the first stage of the two stage model scores all the transactions it receives. In accordance with some aspects of the subject matter described herein some of the transactions emerging from the logistic regression are labeled. The scored transactions produced by the first stage can be separated into four groups. The top-scoring (riskiest) p % of the transactions are labeled “bad” by the first stage. The lowest-scoring (safest) bottom q % of the transactions are labeled “good” by the first stage. A first mid-scoring group represents the group of transactions that the current model approved, for which the status (either good or bad) is known. This group is not labeled by the first stage. The second mid-scoring group represents the transactions the current model rejected for which the status is unknown. This group is not labeled by the first stage either.

The transactions the first stage labeled “bad”, i.e., the riskiest p % of the transactions (e.g., the top 10% of the transactions having the highest risk scores), can be rejected. The transactions the first stage labeled “good”, i.e., the safest q % of the transactions (e.g., the bottom 15% of the transactions having the lowest risk scores), can be approved. The remaining transactions (e.g., the other 75% of the transactions) can be called mid-scored transactions. The mid-scored transactions belong to either a first group or a second group. The first group of the mid-scored transactions are transactions that the current model approved. The status of these transactions (either actually good or actually bad) is known. These transactions are used to build the second stage of the two stage risk model. The second group of the mid-scored transactions are transactions that the current model rejected and therefore no information concerning their status is available. This group of transactions is removed from the second stage of the two stage modeling process because the focus of the second stage is to capture the bad transactions which are misclassified as good in the current model.

The decision to approve or reject transactions in the first mid-scoring group (the group for which status is known) by labeling them “good” or “bad”, can be decided by the second stage of the two stage risk model. In a second stage of the model building process, a model can be built using the first mid-scoring group applying an equal weighting schema. The transactions for which a decision (approve/reject/discard) was not made by the first stage model can be made by the second stage based on achieving a desired reject rate within this group of transactions.

In model evaluation, how users behave when their transactions are rejected can be taken into account. For example, when a non-fraudulent user's transaction is rejected, the non-fraudulent user may retry the transaction a number of times, trying to make the transaction go through. Suppose the good user attempts to place an order for 6 items and his transaction is rejected. If the user tries to place his order 9 more times, without accounting for this behavior in model evaluation, it would look as if 60 items were being ordered instead of 6, erroneously inflating the net profit value of the rejected transaction(s).

When a model is evaluated, user behavior can be taken into account by using a discount rate (e.g., r) for a good user. The retry discount rate for a good user can be estimated by determining the approximate number of retries needed to get one approved transaction. The discount rate for a good user can be calculated by dividing the number of approved transactions by the number of rejected transactions from the return good users. A return good user is a user whose actually good transaction was rejected but retried the transaction and was approved. Similarly, when a fraudulent user's transaction is rejected, the fraudulent user may try to quickly enter transactions before he is discovered. This behavior is accounted for by a discount rate (e.g., s) for a bad user. The discount rate for a bad user can be estimated by calculating the number of approved actually bad transactions divided by the number of rejected transactions from the return bad users.

One of the measurable metrics that a model can attempt to maximize is revenue. In accordance with some aspects of the subject matter described herein, revenue can be measured for a current model using the labeling decisions made by the current model and known transactions status determined by the current model. A current model can be a traditional model created using known machine learning techniques. Net profit values for a current model can be calculated as follows. The net profit value for an approved transaction that is correctly labeled (the approved transaction is actually good) is the profit margin expressed as a percentage of the sales price (revenue). The net profit value when a bad transaction is incorrectly labeled (the approved transaction is actually bad) is the negative (i.e., a loss) of (100% minus the profit margin expressed as a percentage of the sales price) multiplied by the sales price. The net profit value for a rejected transaction that is correctly labeled or incorrectly labeled (the status of a rejected transaction is unknown) is zero. The model's net profit value can be calculated by adding the net profit values for all transactions.

Net profit values for a new two stage risk model can be based on the decisions made by the new model and the status of the transaction determined by the current model. The net profit value for an actually good transaction that the current model approved and the second stage of the model approved is the sales price multiplied by the profit margin. The net profit value for an actually bad transaction that was approved by both the current and the new model is the negative of (100% minus the profit margin expressed as a percentage of the sales price) multiplied by the sales price. The net profit value for an actually good transaction that was rejected by the current model and approved by the new model is the sales price multiplied by the profit margin multiplied by the discount rate for a good user (to account for retries). The net profit value for an actually bad transaction that was correctly labeled and rejected by the current model and incorrectly labeled and approved by the new model is the negative (i.e. a loss) of (100% minus the profit margin expressed as a percentage of the sales price) multiplied by the sales price multiplied by the discount rate for a bad user (to account for retries). The net profit value for a transaction of unknown status (rejected by the current model while approved by the new model) is the sales price multiplied by the profit margin multiplied by the retry discount rate for the good user minus ((100% minus the profit margin) multiplied by the sales price multiplied by the retry discount rate for a bad user). The net profit value for a transaction rejected by the new model (regardless of how the transaction was labeled and whether the transaction was approved or rejected by the current model) is zero.

The new model's net profit value can be estimated by adding together the estimated net profit values for all transactions. The estimate can be a function of r and s such as, for example, NPV(r, s), with a form of a*r+b*s+c where a, b and c are constants driven by the modeling data set. Using an existing training dataset, a first value for r and s (r1, s1) can be selected in a first step. Sets of r and s such as (r1, s1), (r2, s2) and (r3, s3) can be randomly chosen values. If there is a body of knowledge based on business experience, the values can be based on this knowledge. A greedy algorithm can be applied to the model building process to determine values for x, y, z, p and q which maximize a*r1+b*s1+c. A greedy algorithm is an algorithm that follows a problem solving heuristic in which a locally optimal choice is made at each stage in the hope of finding a global optimum. While a greedy strategy may not produce an optimal solution, a greedy heuristic may yield locally optimal solutions that approximate a global optimal solution and may do so relatively quickly.

In a third step, steps 1 and 2 can be repeated with multiple sets of model evaluation parameters, (for example, with (r2, s2) and (r3, s3)) to obtain their maximum values such as for example, a2*r2+b2*s2+c2 and a3*r3+b3*s3+c3. In this example, three models exist, none of which is guaranteed to be optimal. In a fourth step the users can be randomly divided into multiple (e.g., three) groups. Each of the multiple models can be experimentally applied to each of the multiple groups. The models can be allowed to run for a period of time. In a fifth step, NPV can be calculated for each group. That is, in this example, NPV(r1, s1), NPV(r2, s2) and NPV(r3, r3) can be calculated on the three groups using the NPV calculation for the current model method. In a sixth step, the equations

(NPV(r1,s1))/(a1*r+b1*s+c1)=(NPV(r2,s2))/(a2*r+b2*s+c2)=(NPV(r3,s3))/(a3*r+b3*s+c3)

can be solved for r and s to estimate values for r and s. Using the estimated values for r and s, in a seventh step the greedy algorithm can be applied to the model building process to determine values for x, y, z p and q which maximize a1*r1+b1*s1+c1. Each different set of r and s can be associated with a set of values for x, y, z, p, and q which maximizes net profit value and can be solved using a greedy algorithm. The resulting total net profit values for each instance can be compared and the parameters associated with the instance that maximizes revenue can be selected for the new model. While described within the context of a transaction-based computerized system, the concepts described herein can be applied to any supervised classification problem where the true status of rejected transactions is not available.

### Two Stage Risk Model Building and Model Evaluation

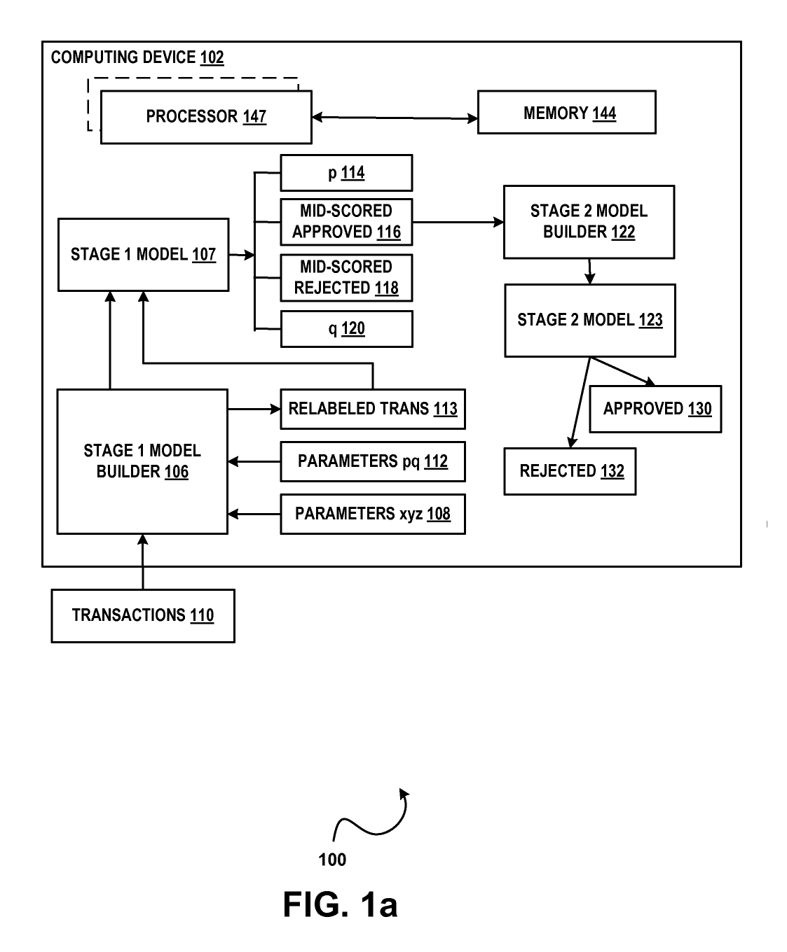

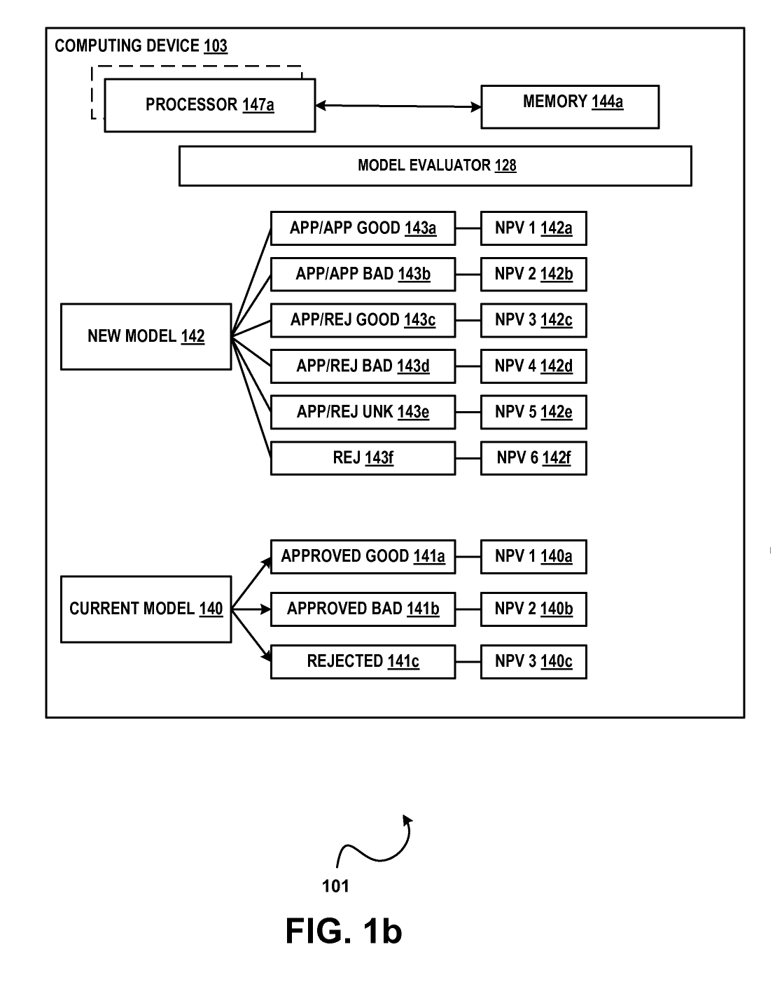

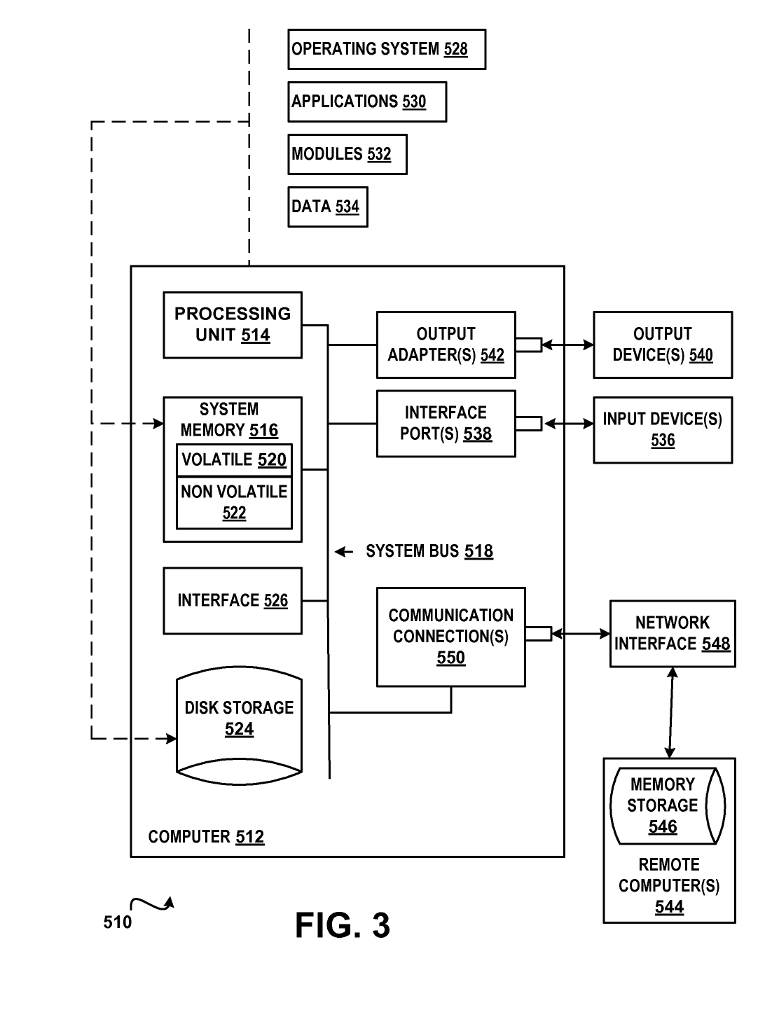

FIG. 1a illustrates a block diagram of an example of a system 100 that builds a two stage risk model in accordance with aspects of the subject matter disclosed herein. All or portions of system 100 may reside on one or more computers or computing devices such as the computers described below with respect to FIG. 3. System 100 or portions thereof may be provided as a stand-alone system or as a plug-in or add-in.

System 100 or portions thereof may include information obtained from a service (e.g., in the cloud) or may operate in a cloud computing environment. A cloud computing environment can be an environment in which computing services are not owned but are provided on demand. For example, information may reside on multiple devices in a networked cloud and/or data can be stored on multiple devices within the cloud.

System 100 can include one or more computing devices such as, for example, computing device 102. Contemplated computing devices include but are not limited to desktop computers, tablet computers, laptop computers, notebook computers, personal digital assistants, smart phones, cellular telephones, mobile telephones, and so on. A computing device such as computing device 102 can include one or more processors such as processor 147, etc., and a memory such as memory 144 that communicates with the one or more processors.

System 100 can include one or more program modules that comprise a risk model. The risk model can comprise a first stage and a second stage. In FIG. 1a, one or more program modules that perform the actions of building a first stage of a two stage risk model are represented by stage 1 model builder 106. The first stage of the model (stage 1 model 107 in FIG. 1a) in accordance with aspects of the subject matter described herein can include algorithms that identify aspects of bad transactions and patterns of aspects that are associated with bad transactions. Each transaction received can be examined and scored. Scoring means that a degree of probability that the transaction is bad is determined for the transaction. For example, in accordance with aspects of the subject matter described herein, the model created by the first stage of the two stage risk model builder can target patterns of transactions that are fraudulent. The first stage of the model can address identifying false positives. The first stage of the model can address reducing the number of false positives (e.g., reducing the number of actually good transactions that are labeled “bad”.)

Stage 1 model builder 106 can receive transactions such as transaction 110. Transactions can be any type of transactions including but not limited to transactions for a purchasing system including but not limited to order transactions, account set up transactions, add credit card information transactions or any type of transactions associated with purchasing items or services, paying for items or services, setting up account information including but not limited to identification and payment information and so on. Transactions can be received from computing device 102, and/or from one or more remote computers in communication with computing device 102 via any means including but not limited to any type of network. Transactions 110 can be training transactions. Transactions 110 can be transactions received by an existing risk model. Transactions 110 can be actual transactions received and processed by an existing risk model. Transactions 110 can be transactions received from a current live risk model.

Stage 1 model builder 106 may receive parameters such as parameters xyz 108. Parameters xyz 108 can be determined based on the values of r and s estimated as described below. Parameters xyz 108 can include one or more of the following: a parameter such as parameter x representing a weight given to transactions of a first type (e.g., actually good transactions that are correctly labeled by a current model), a parameter y representing a weight given to transactions of a second type (e.g., transactions rejected by a current model) and/or a parameter z representing a weight given to transactions of a third type (e.g., actually bad transactions that are correctly labeled by a current model). In accordance with aspects of the subject matter described herein, a transaction of the first type can be a transaction approved by a current model that is actually good. An actually good transaction can be a known non-fraudulent transaction. A transaction of the second type can be a transaction that is rejected by the current model and whose actual status is not known. The actual status can be fraudulent or non-fraudulent. A transaction of the third type can be a transaction that was approved by the current model but which was determined to be actually bad. An actually bad transaction can be a fraudulent transaction. The transaction can be determined to be actually bad because, for example, a charge made via the computerized transaction system was later reversed.

Stage 1 model builder 106 may receive parameters such as parameters pq 112. Parameters pq 112 can be determined based on business knowledge or based on algorithms. Parameters pq 112 can be calculated or estimated. Parameters pq 112 can include a parameter such as parameter p representing a percentage p of the highest scored transactions from the first stage model, stage 1 model 107. In accordance with some aspects of the subject matter described herein, the highest scored transactions may represent those transactions which have the highest probability of being bad transactions. Parameters pq 112 can include a parameter q representing a percentage of the lowest scored transactions from the first stage model, stage 1 model 107. In accordance with some aspects of the subject matter described herein, the lowest scored transactions may represent those transactions which have the lowest probability of being bad transactions. It will be appreciated that alternatively, the highest scored transactions may represent those transactions which have the lowest probability of being bad transactions while the lowest scored transactions may represent those transactions which have the highest probability of being bad transactions, in which case the meanings of parameters p and q can be reversed.

Stage 1 model builder 106 can relabel transactions 110 to create relabeled transactions 113. Transactions rejected by the current model that were made by good users (good users are users whose approved transactions are good) can be relabeled “good” and transactions rejected by the current model that were made by bad users (whose approved transactions are bad) can be relabeled “bad”. Users that have both good and bad transactions in a short period of time can be excluded from analysis. In the first stage of the two stage model, a logistic regression or other machine learning technique can be performed applying the xyz weighting schema to transactions such as relabeled transactions 113, etc. received by stage 1 model builder 106. The results of the logistic regression or other machine learning technique can be a set of p % of the total transactions p 114, receiving the highest scores, a set of q % of the total transactions q 120 receiving the lowest q percent of the scores, a set of transactions receiving middle scores (less than the highest scored transactions p 114 and greater than the lowest scored transactions q 120) representing mid-scored approved transactions represented in FIG. 1a by mid-scored approved transactions 116, transactions with a known status approved by the current model, and a set of transactions receiving middle scores (less than the highest scored transactions p 114 and greater than the lowest scored transactions q 120) representing mid-scored transactions rejected by the current model represented in FIG. 1a by mid-scored rejected transactions 118.

System 100 can include one or more program modules that comprise a second stage risk model builder of a two stage risk model represented by stage 2 model builder 122 in FIG. 1a. The second stage risk model builder of the two stage risk model, in accordance with aspects of the subject matter described herein, can receive the mid-scored transactions with known status (good or bad) approved by the current model (mid-scored approved transactions 116). A second model (e.g., stage 2 model 123) can be built on the received transactions with equal weighting on all transactions. Stage 2 model 123 can approve transactions (producing approved transaction 130). Stage 2 model 123 can reject transactions (producing rejected transactions 132). The desired reject rate can be used to reject the transactions having the highest scores. Thus the first stage model approves or rejects the easier transactions to label correctly and the second stage model makes decisions on transactions that are not as easy to label correctly.

FIG. 1b illustrates a system 101 that can evaluate a current and a new model in accordance with aspects of the subject matter described herein. All or portions of system 101 may reside on one or more computers or computing devices such as the computers described below with respect to FIG. 3. System 101 or portions thereof may be provided as a stand-alone system or as a plug-in or add-in.

System 101 or portions thereof may include information obtained from a service (e.g., in the cloud) or may operate in a cloud computing environment. A cloud computing environment can be an environment in which computing services are not owned but are provided on demand. For example, information may reside on multiple devices in a networked cloud and/or data can be stored on multiple devices within the cloud.

System 101 can include one or more computing devices such as, for example, computing device 103. Contemplated computing devices include but are not limited to desktop computers, tablet computers, laptop computers, notebook computers, personal digital assistants, smart phones, cellular telephones, mobile telephones, and so on. A computing device such as computing device 103 can include one or more processors such as processor 147a, etc., and a memory such as memory 144a that communicates with the one or more processors.

System 101 can include one or more program modules that comprise a risk model evaluator such as risk model evaluator 128. A risk model evaluator such as risk model evaluator 128 can evaluate a risk model in terms of a measurable metric. In accordance with some aspects of the subject matter described herein, the measurable goal by which a model is evaluated is revenue. The risk model evaluator can, for example, evaluate a current model and a new model to determine which model maximizes net profit value (NPV). A current model such as current model 140 can be an existing model created using known machine learning techniques. A current model can be an existing two stage risk model as described above. A new model such as new model 142 can be a two stage risk model as described above.

Net profit values for a current model 140 can be calculated as follows. The net profit value (NPV 1 140a) for an approved transaction such as approved transaction 141a that is correctly labeled (the approved transaction is actually good) is the profit margin expressed as a percentage of the sales price (revenue). The net profit value (NPV 2 140b) when a bad transaction such as approved bad transaction 141b is incorrectly labeled (the approved transaction is actually bad) is the negative (i.e., a loss) of (100% minus the profit margin expressed as a percentage of the sales price) multiplied by the sales price. The net profit value (NPV 3 140c) for a rejected transaction (such as rejected transaction 141c) that is correctly labeled or incorrectly labeled (the status of a rejected transaction is unknown) is zero. The model's net profit value can be calculated by adding the net profit values for all transactions.

Risk model evaluator 128 can take into account how users behave when their transactions are rejected. For example, when a non-fraudulent user's transaction is rejected, the non-fraudulent user may retry the transaction a number of times, trying to make the transaction go through. Suppose the good user attempts to place an order for 6 items and his transaction is rejected. If the user tries to place his order 9 more times, without accounting for this behavior, it would look as if 60 items were being ordered instead of 6, erroneously inflating the net profit value of the rejected transaction(s). In accordance with some aspects of the subject matter described herein, this behavior can be taken into account by using a discount rate (e.g., r) for a good user. The retry discount rate for a good user can be estimated by determining the approximate number of retries needed to get one approved transaction. The discount rate for a good user can be calculated by dividing the number of approved transactions by the number of rejected transactions from the return good users. A return good user is a user who was rejected but retried and was approved. Similarly, when a fraudulent user's transaction is rejected, the fraudulent user may try to quickly enter transactions before he is discovered. This behavior can be accounted for by a discount rate (e.g., s) for a bad user. The discount rate for a bad user can be estimated by calculating the number of approved transactions divided by the number of rejected transactions from the return bad users.

Net profit values (e.g., NPV 1 142a, NPV 2 142b, NPV 3 142c, NPV 4 142d, NPV 5 142e, NPV 6 1420 for the new model (e.g., new model 142) can be based on the processing decision made by the combined decisions made by the first and second stages of the two stage risk model (new model 142) and the status of the transaction determined by the current model 140. The net profit value (NPV 1 142a) for an actually good transaction that the current model approved and the second stage of the model approved (e.g., approved/approved good transaction 143a) is the sales price multiplied by the profit margin. The net profit value (NPV 2 142b) for an actually bad transaction that was approved by both the current and the new model (e.g., approved/approved bad transaction 143b) is the negative of (100% minus the profit margin expressed as a percentage of the sales price) multiplied by the sales price. The net profit value (NPV 3 142c) for an actually good transaction (e.g., approved/rejected good transaction 143c) that was rejected by the current model and approved by the new model is the sales price multiplied by the profit margin multiplied by the discount rate for a good user (to account for retries). The net profit value (NPV 4 142d) for an actually bad transaction that was correctly labeled and rejected by the current model and incorrectly labeled and approved by the new model (e.g., approved/rejected bad transaction 143d) is the negative (i.e. a loss) of (100% minus the profit margin expressed as a percentage of the sales price) multiplied by the sales price multiplied by the discount rate for a bad user (to account for retries). The net profit value (NPV 5 142e) for a transaction of unknown status (rejected by the current model while approved by the new model (e.g., approved/rejected unknown transaction 143e) is the sales price multiplied by the profit margin multiplied by the retry discount rate for the good user minus ((100% minus the profit margin) multiplied by the sales price multiplied by the retry discount rate for a bad user). The net profit value (NPV 6 1420 for a transaction rejected by the new model regardless of the decision and labeling from the current model (e.g., rejected transaction 1430 is zero.

The new model's net profit value can be estimated by adding together the estimated net profit values for all transactions. The estimate can be a function of r and s such as, for example, NPV(r, s), with a form of a*r+b*s+c where a, b and c are constants driven by the modeling data set. (The constant a can represent the number of approved transactions divided by the number of rejected transactions from the return good users; the constant b can represent the number of approved transactions divided by the number of rejected transactions from the return bad users and the constant c can represent the NPV from the transactions with known status. Using an existing training dataset, a first value for r and s (r1, s1) can be selected in a first step. (r1, s1), (r2, s2) and (r3, s3) can be randomly chosen values. If there is a body of knowledge based on business experience, the values of the different sets of r and s can be based on this knowledge.

A greedy algorithm can be applied to the model building process to determine values for x, y, z, p and q which maximize a*r1+b*s1+c. Suppose the maximum value is a1*r1+b1*s1+c1. A greedy algorithm is an algorithm that follows a problem solving heuristic in which a locally optimal choice is made at each stage in the hope of finding a global optimum. While a greedy strategy may not produce an optimal solution, a greedy heuristic may yield locally optimal solutions that approximate a global optimal solution and may do so relatively quickly. In a third step, steps 1 and 2 can be repeated with different sets of model evaluation parameters, (for example, with (r2, s2) and (r3, s3)) to obtain their maximum values a2*r2+b2*s2+c2 and a3*r3+b3*s3+c3. Now three models exist, none of which is guaranteed to be optimal.

In a fourth step the users can be randomly divided into three groups. Each of the three models can be experimentally applied to each of the groups. The models can be allowed to run for a period of time. In a fifth step, NPV can be calculated for each group. That is, NPV(r1, s1), NPV(r2, s2) and NPV(r3, r3) can be calculated on the three groups using the NPV calculation for the current model method. In a sixth step, the equations

(NPV(r1,s1))/(a1*r+b1*s+c1)=(NPV(r2,s2))/(a2*r+b2*s+c2)=(NPV(r3,s3))/(a3*r+b3*s+c3)

can be solved for r and s to estimate values for r and s. Using the estimated values for r and s, in a seventh step the greedy algorithm can be applied to the model building process to determine values for x, y, z p and q which maximize a1*r1+b1*s1+c1. Each different set of r and s can be associated with a set of values for x, y, z, p, and q which maximizes net profit value and can be solved using a greedy algorithm. The resulting total net profit values for each instance can be compared and the parameters associated with the instance that maximizes revenue can be selected for a future model.

While described within the context of a transaction-based computerized system, the concepts described herein can be applied to any supervised classification problem where the true status of rejected transactions is not available. A supervised classification problem is one in which good test data is labeled good and bad test data is labeled bad. The labeled test data is provided to the model as training data sets.

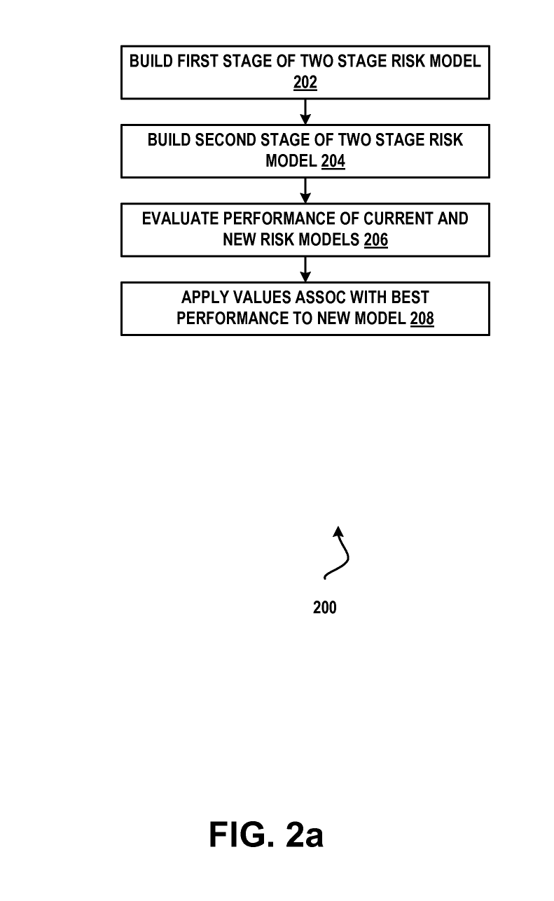

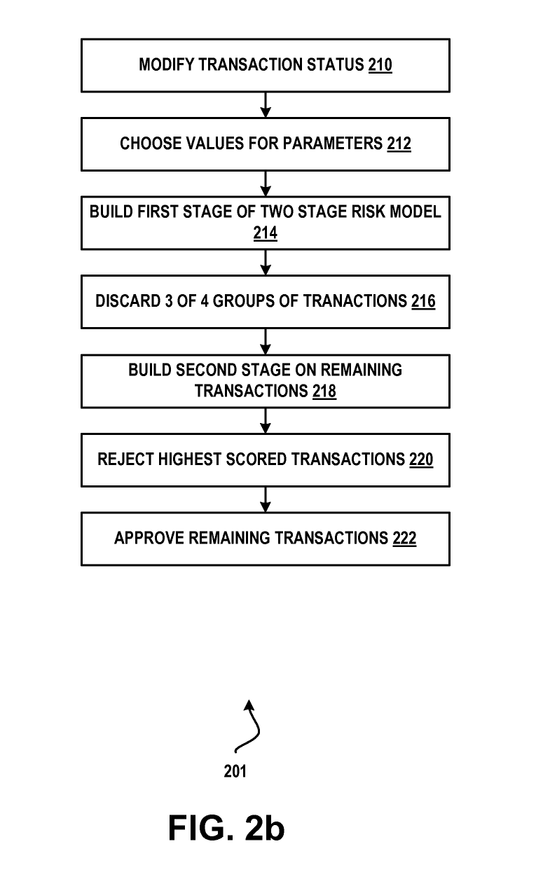

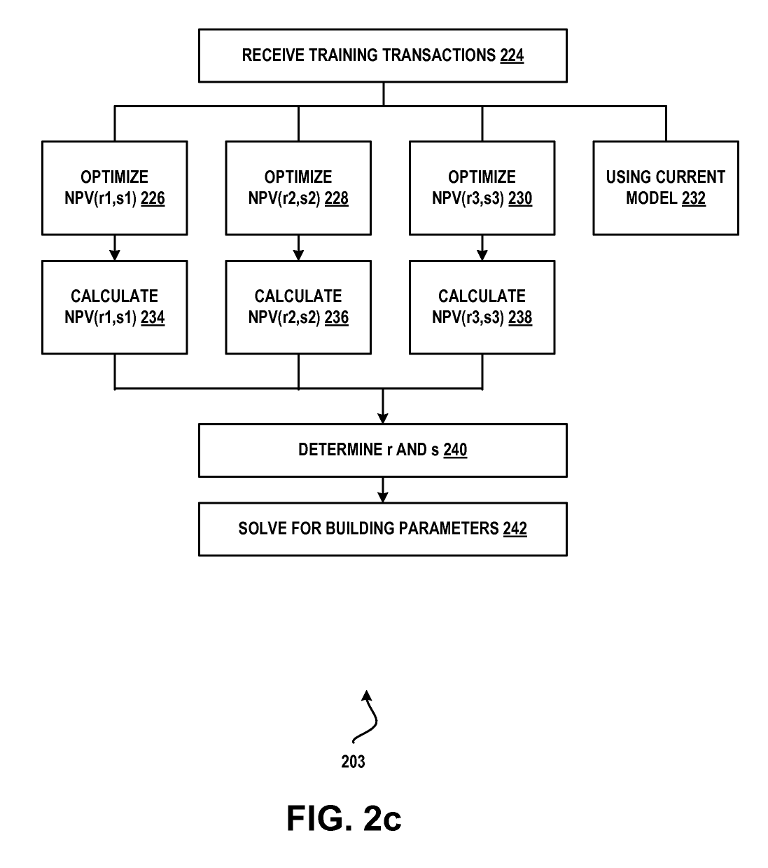

FIG. 2a illustrates an example of a method 200 for two stage risk model building in accordance with aspects of the subject matter described herein. Portions of the method described in FIG. 2a can be practiced by a system such as but not limited to the one described with respect to FIG. 1a. Portions of the method described in FIG. 2a can be practiced by a system such as but not limited to the one described with respect to FIG. 1b. While method 200 describes a series of operations that are performed in a sequence, it is to be understood that method 200 is not limited by the order of the sequence depicted. For instance, some operations may occur in a different order than that described. In addition, one operation may occur concurrently with another operation. In some instances, not all operations described are performed. At operation 202, a first stage of a new risk model is built, as described more fully above. At operation 204 a second stage of a new risk model is built, as described more fully above. At operation 206 a current risk model and the new risk model can be evaluated. In response to determining that the new model maximizes a measurable metric at operation 208 the values of the parameters that maximize the measurable metric can be chosen for an updated (future) model.

FIG. 2b illustrates a more detailed example of portions of the method of FIG. 2a for two stage risk model building in accordance with aspects of the subject matter described herein. Method 201 described in FIG. 2b can be practiced by a system such as but not limited to the one described with respect to FIG. 1a. While method 201 describes a series of operations that are performed in a sequence, it is to be understood that method 201 is not limited by the order of the sequence depicted. For instance, some operations may occur in a different order than that described. In addition, one operation may occur concurrently with another operation. In some instances, not all operations described are performed.

In method 201, at operation 210 transaction status of transactions received from a current model can be relabeled based on known information, as described more fully above. At operation 212 values for parameters x, y, z, p and q can be chosen, as described more fully above. At operation 214 the first stage of the two stage risk model can be built by miming a logistical regression using the xyz weighting schema described above on the relabeled transactions. Alternatively, other machine learning techniques can be used to create the first stage of the risk model. At operation 216 the top p % of the highest scored transactions, the bottom q % of the lowest scored transactions and the rejected transactions from the first stage of the model can be discarded (i.e., excluded from being provided to the second stage of the model). At operation 218 the second stage of the risk model can be built on the remaining (undiscarded) equally weighted transactions. At operation 220, the highest scored transactions can be rejected to achieve a desired reject rate. At operation 222 the remaining transactions can be approved.

FIG. 2c illustrates an example of a method 203 to evaluate risk models in accordance with aspects of the subject matter described herein. Method 203 described in FIG. 2c can be practiced by a system such as but not limited to the one described with respect to FIG. 1b. While method 203 describes a series of operations that are performed in a sequence, it is to be understood that method 203 is not limited by the order of the sequence depicted. For instance, some operations may occur in a different order than that described. In addition, one operation may occur concurrently with another operation. In some instances, not all operations described are performed.

In method 203, at operation 224 a set of training transactions can be received. In accordance with some aspects of the subject matter described herein, a random sample of users (e.g., k % of the total transaction population) can be selected from the set of training transactions for evaluation of the models. In accordance with some aspects of the subject matter 1-3% of the users are selected. At operation 226 a greedy algorithm can be applied to solve for model building parameters which optimize an estimated measurable metric such as a first NPV associated with a first set of input parameters r1 and s1, described more fully above, in which a specified percentage k of users are approved or rejected by an optimal model. At operation 228 a greedy algorithm can be applied to solve model building parameters which optimize an estimated measurable metric such as a second NPV associated with a second set of input parameters r2 and s2, described more fully above, in which a specified percentage k of users are approved or rejected by an optimal model.

At operation 230 a greedy algorithm can be applied to solve for model building parameters which optimize an estimated measurable metric such as a third NPV associated with a third set of input parameters r2 and s2, described more fully above, in which a specified percentage k of users are approved or rejected by an optimal model. It will be appreciated by those of skill in the art that although in this example, three sets of r and s are used, any number of sets of r and s can be used to from which to generate NPVs for comparison. At operation 232 NPV generated from the current model for the selected k % of users can be determined. Operations 226, 228, 230 and 232 can be performed in parallel or serially or in any way. At operation 234 the NPV associated with parameters r1 and s1 can be calculated based on empirical results. At operation 236 the NPV associated with parameters r2 and s2 can be calculated based on empirical results. At operation 238 the NPV associated with parameters r3 and s3 can be calculated based on empirical results. Operations 234, 236, and 238 can be performed in parallel or serially or in any way. At operation 240 the value for r and s that maximizes NPV can be determined. At operation 242 a greedy algorithm can be applied to solve model building parameters which optimize estimated NPV(r,$). These values can be used to create a future model.

### Example of a Suitable Computing Environment

In order to provide context for various aspects of the subject matter disclosed herein, FIG. 3 and the following discussion are intended to provide a brief general description of a suitable computing environment 510 in which various embodiments of the subject matter disclosed herein may be implemented. While the subject matter disclosed herein is described in the general context of computer-executable instructions, such as program modules, executed by one or more computers or other computing devices, those skilled in the art will recognize that portions of the subject matter disclosed herein can also be implemented in combination with other program modules and/or a combination of hardware and software. Generally, program modules include routines, programs, objects, physical artifacts, data structures, etc. that perform particular tasks or implement particular data types. Typically, the functionality of the program modules may be combined or distributed as desired in various embodiments. The computing environment 510 is only one example of a suitable operating environment and is not intended to limit the scope of use or functionality of the subject matter disclosed herein.

With reference to FIG. 3, a computing device in the form of a computer 512 is described. Computer 512 may include at least one processing unit 514, a system memory 516, and a system bus 518. The at least one processing unit 514 can execute instructions that are stored in a memory such as but not limited to system memory 516. The processing unit 514 can be any of various available processors. For example, the processing unit 514 can be a graphics processing unit (GPU). The instructions can be instructions for implementing functionality carried out by one or more components or modules discussed above or instructions for implementing one or more of the methods described above. Dual microprocessors and other multiprocessor architectures also can be employed as the processing unit 514. The computer 512 may be used in a system that supports rendering graphics on a display screen. In another example, at least a portion of the computing device can be used in a system that comprises a graphical processing unit. The system memory 516 may include volatile memory 520 and nonvolatile memory 522. Nonvolatile memory 522 can include read only memory (ROM), programmable ROM (PROM), electrically programmable ROM (EPROM) or flash memory.

Volatile memory 520 may include random access memory (RAM) which may act as external cache memory. The system bus 518 couples system physical artifacts including the system memory 516 to the processing unit 514. The system bus 518 can be any of several types including a memory bus, memory controller, peripheral bus, external bus, or local bus and may use any variety of available bus architectures. Computer 512 may include a data store accessible by the processing unit 514 by way of the system bus 518. The data store may include executable instructions, 3D models, materials, textures and so on for graphics rendering.

Computer 512 typically includes a variety of computer readable media such as volatile and nonvolatile media, removable and non-removable media. Computer readable media may be implemented in any method or technology for storage of information such as computer readable instructions, data structures, program modules or other data. Computer readable media include computer-readable storage media (also referred to as computer storage media) and communications media. Computer storage media includes physical (tangible) media, such as but not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices that can store the desired data and which can be accessed by computer 512. Communications media include media such as, but not limited to, communications signals, modulated carrier waves or any other intangible media which can be used to communicate the desired information and which can be accessed by computer 512.

It will be appreciated that FIG. 3 describes software that can act as an intermediary between users and computer resources. This software may include an operating system 528 which can be stored on disk storage 524, and which can allocate resources of the computer 512. Disk storage 524 may be a hard disk drive connected to the system bus 518 through a non-removable memory interface such as interface 526. System applications 530 take advantage of the management of resources by operating system 528 through program modules 532 and program data 534 stored either in system memory 516 or on disk storage 524. It will be appreciated that computers can be implemented with various operating systems or combinations of operating systems.

A user can enter commands or information into the computer 512 through an input device(s) 536. Input devices 536 include but are not limited to a pointing device such as a mouse, trackball, stylus, touch pad, keyboard, microphone, voice recognition and gesture recognition systems and the like. These and other input devices connect to the processing unit 514 through the system bus 518 via interface port(s) 538. An interface port(s) 538 may represent a serial port, parallel port, universal serial bus (USB) and the like. Output devices(s) 540 may use the same type of ports as do the input devices. Output adapter 542 is provided to illustrate that there are some output devices 540 like monitors, speakers and printers that require particular adapters. Output adapters 542 include but are not limited to video and sound cards that provide a connection between the output device 540 and the system bus 518. Other devices and/or systems or devices such as remote computer(s) 544 may provide both input and output capabilities.

Computer 512 can operate in a networked environment using logical connections to one or more remote computers, such as a remote computer(s) 544. The remote computer 544 can be a personal computer, a server, a router, a network PC, a peer device or other common network node, and typically includes many or all of the elements described above relative to the computer 512, although only a memory storage device 546 has been illustrated in FIG. 3. Remote computer(s) 544 can be logically connected via communication connection(s) 550. Network interface 548 encompasses communication networks such as local area networks (LANs) and wide area networks (WANs) but may also include other networks. Communication connection(s) 550 refers to the hardware/software employed to connect the network interface 548 to the bus 518. Communication connection(s) 550 may be internal to or external to computer 512 and include internal and external technologies such as modems (telephone, cable, DSL and wireless) and ISDN adapters, Ethernet cards and so on.

It will be appreciated that the network connections shown are examples only and other means of establishing a communications link between the computers may be used. One of ordinary skill in the art can appreciate that a computer 512 or other client device can be deployed as part of a computer network. In this regard, the subject matter disclosed herein may pertain to any computer system having any number of memory or storage units, and any number of applications and processes occurring across any number of storage units or volumes. Aspects of the subject matter disclosed herein may apply to an environment with server computers and client computers deployed in a network environment, having remote or local storage. Aspects of the subject matter disclosed herein may also apply to a standalone computing device, having programming language functionality, interpretation and execution capabilities.

The various techniques described herein may be implemented in connection with hardware or software or, where appropriate, with a combination of both. Thus, the methods and apparatus described herein, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing aspects of the subject matter disclosed herein. As used herein, the term “machine-readable storage medium” shall be taken to exclude any mechanism that provides (i.e., stores and/or transmits) any form of propagated signals. In the case of program code execution on programmable computers, the computing device will generally include a processor, a storage medium readable by the processor (including volatile and non-volatile memory and/or storage elements), at least one input device, and at least one output device. One or more programs that may utilize the creation and/or implementation of domain-specific programming models aspects, e.g., through the use of a data processing API or the like, may be implemented in a high level procedural or object oriented programming language to communicate with a computer system. However, the program(s) can be implemented in assembly or machine language, if desired. In any case, the language may be a compiled or interpreted language, and combined with hardware implementations.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A system comprising:
at least one processor:
a memory connected to the at least one processor; and
at least one module that when loaded into the at least one processor causes the at least one processor to:
build a first stage of a two stage risk model, the first stage of the two stage risk model focused on capturing currently known patterns associated with bad transactions; and
build a second stage of the two stage risk model, the second stage rejecting transactions that are approved by a current risk model but that are actually bad.

2. The system of claim 1, further comprising a module that when loaded into the at least one processor causes the at least one processor to:
relabel transactions received from the current risk model so that rejected transactions received from a good user are relabeled “good”.

3. The system of claim 1, further comprising a module that when loaded into the at least one processor causes the at least one processor to:
relabel transactions received from the current risk model so that rejected transactions received from a bad user are relabeled “bad”.

4. The system of claim 1, further comprising:
a module that when loaded into the at least one processor causes the at least one processor to:
assign a first weight in a weighting schema to a transaction of a first type comprising an actually good transaction that has been approved by the current risk model;
assign a second weight in the weighting schema to a transaction of a second type comprising a transaction rejected by the current model, wherein a status associated with the transaction of the second type is unknown;
assign a third weight in the weighting schema to a transaction of a third type comprising an actually bad transaction approved by the current risk model.

5. The system of claim 4, further comprising:
a module that when loaded into the at least one processor causes the at least one processor to:
generate the first stage of the two stage risk model by performing a weighted logistical regression on a plurality of transactions, the plurality of transactions including relabeled transactions;
score the plurality of transactions;
discard a specified percentage of top-scored transactions;
discard a specified percentage of lowest-scored transactions;
discard transactions rejected by the current risk model; and
provide remaining transactions to the second stage of the two stage risk model, the second stage generated by performing an equal weighted logistic regression on the remaining transactions.

6. The system of claim 5, further comprising:
a module that when loaded into the at least one processor causes the at least one processor to:
evaluate the performance of the current risk model and the two stage risk model based on maximizing a measurable metric using a first parameter comprising a discount rate to account for multiple transactions placed by a good user whose transaction is rejected and based on a second parameter comprising a discount rate to account for multiple transactions placed by a bad user whose transaction is rejected.

7. The system of claim 1, further comprising:
a module that when loaded into the at least one processor causes the at least one processor to:
instantiate a plurality of instances of the two stage risk model, wherein each instance of the plurality of instances is provided with a different set of first and second parameters;
determine the instance maximizing revenue, the revenue for each instance measured by comparing total net profit produced by each instance; and
use the set of first and second parameters associated with the instance that maximized revenue for a future model.

8. A method comprising:
creating a two stage risk analysis model within the memory of a computer, the two stage risk analysis model comprising a first stage of risk analysis for a computerized transaction-based system and a second stage of risk analysis for the computerized transaction-based system, the first stage of risk analysis identifying patterns of characteristics of bad transactions, the second stage of risk analysis rejecting actually bad transactions approved by a current risk model.

9. The method of claim 8, further comprising:
relabeling at least one of a plurality of transactions received from the current risk model by at least one processor of a computing device comprising a two stage risk model, the relabeling based on a known status of a user associated with the at least one transaction;
weighting the plurality of transactions based on a type of each transaction in the plurality of transactions;
performing a first logistic regression on the weighted plurality of transactions to create the first stage of the two stage risk model;
performing a second equal-weighted logistic regression on transactions of known status generated by the first stage of the two stage risk model to generate the second stage of the two stage risk model; and
rejecting a specified percentage of resulting transactions.

10. The method of claim 8, wherein bad transactions are fraudulent transactions.

11. The method of claim 8, wherein the computerized transaction-based system is an order processing system.

12. The method of claim 9, further comprising:
evaluating the current risk model for total net profit generated for a randomly selected subset of a transaction population; and
evaluating the two stage risk model for total net profit generated for the randomly selected subset of the transaction population.

13. The method of claim 8, further comprising:
creating a plurality of instances of the two stage risk model using different sets of parameters; and
determining an instance of the plurality of instances that maximizes a measurable metric of the computerized transaction-based system.

14. A computer-readable storage medium comprising computer-readable instructions which when executed cause at least one processor of a computing device to:
evaluate a current model and a two stage risk model, the evaluation based on a measurable metric.

15. The computer-readable storage medium of claim 14, comprising further computer-readable instructions which when executed cause the at least one processor to:
randomly select a subset of a total transaction population generated by the current model;
solve for model building parameters which optimize net profit value associated with a first set of input parameters;
solve for model building parameters which optimize a net profit value associated with at least a second set of input parameters;
calculate the total net profit value generated by the current model for the subset;
calculate the total net profit value associated with the first set of input parameters;
calculate the total net profit value associated with the at least second set of input parameters;
determine a set of input parameters that maximizes net profit value; and
using the determined set of input parameters, solve for model building parameters.

16. The computer-readable storage medium of claim 14, comprising further computer-readable instructions which when executed cause the at least one processor to:
use the model building parameters to create a future model.

17. The computer-readable storage medium of claim 14, comprising further computer-readable instructions which when executed cause the at least one processor to:
receive a first parameter comprising a discount rate to account for multiple transactions placed by a good user whose transaction is rejected;
receive a second parameter comprising a discount rate to account for multiple transactions placed by a bad user whose transaction is rejected.

18. The computer-readable storage medium of claim 14, comprising further computer-readable instructions which when executed cause the at least one processor to:
instantiate a plurality of instances of the two stage risk model, wherein each instance of the plurality of instances is provided with a different set of first and second parameters;
determine the instance maximizing revenue, the revenue for each instance measured by comparing total net profit produced by each instance; and
use the set of first and second parameters associated with the instance that maximized revenue for a future model.

19. The computer-readable storage medium of claim 18, comprising further computer-readable instructions which when executed cause the at least one processor to:
adjust for retry transactions made by a first type of user with a first parameter and adjusting for retry transactions made by a second type of user with a second parameter; and
determine an instance of the plurality of instances of the two stage of risk model, the instance maximizing a specified metric comprising revenue measured by total net profit generated by each instance.

20. The computer-readable storage medium of claim 19, comprising further computer-readable instructions which when executed cause the at least one processor to:
evaluate the current model and the two stage risk model, the two stage risk model comprising a model for a transaction-based ordering system, the evaluation based on maximizing revenue.
